(19) United States
(12) Patent Application Publication
(10) Pub. No.: US 2006/0209190 A1
(43) Pub. Date: Sep. 21, 2006

(54) Vehicle directional monitoring system

(76) Inventors: Kenneth S. Walters, Germantown, MD (US); Lucinda L. Havranek-Walters, Germantown, MD (US)

Correspondence Address: HALL, MYERS, VANDE SANDE & PEQUIGNOT, LLP, 10220 RIVER ROAD, SUITE 200, POTOMAC, MD, 20854, US

(21) Appl. No.: 11/073,356

(22) Filed: Mar. 4, 2005

(51) Int. Cl. H04N 7/18; B60Q 1/00; G08G 1/14

(52) U.S. Cl. 348/148; 340/435; 340/932.2

(57) ABSTRACT

A camera system and associated viewing monitor for use during directional operation of passenger and commercial vehicles. More particularly, a camera system mountable on a vehicle for collecting images in a rearward direction thereof and a monitor, mountable in a vehicle's passenger compartment, for viewing images collected by the camera system.

### RELATED APPLICATION DATA

This application claims priority of U.S. patent application Ser. No. 10/793,625, filed Mar. 4, 2004, entitled CLOSE VIEW SYSTEM, the entirety of which is hereby incorporated by reference.

### FIELD OF INVENTION

This invention relates to a camera system and associated viewing monitor for use during directional operation of passenger and commercial vehicles. More particularly, this invention relates to a camera system mountable on a vehicle for collecting images in a rearward direction thereof and a monitor, mountable in a vehicle's passenger compartment, for viewing images collected by the camera system.

### BACKGROUND OF THE INVENTION

As is generally known in the industry, various federal and state laws require that vehicles operating on public roads be equipped with certain safety features. For example, it is a requirement that both rear and side-view type mirrors be installed on most, if not all, classes of commercial and passenger vehicles in the United States.

In this regard, rear and side-view type mirrors are required so that the areas behind and to the sides of a vehicle can be viewed during certain vehicle maneuvers to provide both safety to the driver and vehicle passengers as well as to the public at large. Although side and rear-view type mirrors have been utilized in the automotive industry for decades, such conventional mirrors exhibit many drawbacks. For instance, conventional mirrors as they are presently known display limited fields of view and are therefore prone to have so-called blind spots i.e. areas which the mirrors do not allow the vehicle driver to view. Typically such blind spots are located in areas in close proximity to the vehicle, in certain areas parallel to portions of the vehicle, and at areas below the level of the trunk of the vehicle (i.e. which can't be seen because of the obstruction of various parts of the vehicle itself) e.g. at curb level. Due to the presence of such blind spots (such as when “reversing” a vehicle in a parking lot), vehicle drivers often attempt to compensate for such blind spots when maneuvering a vehicle by turning their heads to check for adjacent objects (and therefore removing their eyes from the principal traveling direction), getting out of the vehicle to check for distances between the vehicle and other vehicles or objects, and/or simply operating the vehicle in a rearward direction while simply ignoring any blind spots (therefore putting both nearby property and persons in considerable danger).

As another drawback to conventionally known vehicle mirrors, due to differing driver heights and multiple possible seat positions (i.e. in vehicles with adjustable seats), both side and rear-view mirror orientations or positions require frequent adjustment in order so that a perceived optimized viewing area can be selected by the driver. Moreover, because of the tedious nature of adjusting conventional mirrors or the inaccessibility of a mirror located on the opposite side of a vehicle, often a driver makes no adjustments at all, thus rendering the usefulness of the mirrors marginal at best.

In efforts to address the aforedescribed drawbacks in the automotive vehicle arts, various efforts have been made in the industry to develop supplemental viewing devices for use in conjunction with conventional vehicle mirrors. In this regard, a number of supplemental viewing systems have been developed which utilize a camera which transmits images to a display screen located in the passenger compartment of a vehicle. Several patents which disclose such supplemental viewing systems are discussed immediately below.

For example, U.S. Pat. No. 5,680,123 (issued to Lee) discloses a vehicle monitoring system which utilizes a plurality of video cameras mounted to the vehicle so that otherwise difficult to see objects can be viewed by the vehicle operator. In one embodiment of the U.S. Pat. No. '123, images collected by the cameras are displayed or recorded in response to the position of a turn signal control switch. In another embodiment, the cameras are activated when a vehicle security alarm is triggered or when the vehicle is impacted by another vehicle.

Other documents which disclose vehicle camera systems are, in no particular order, U.S. Pat. Nos. 5,793,420; 6,211,907; 6,333,759, and U.S. Patent Publication Nos. 2002/0171738 and 2003/0041329. Example features which these patents describe are motion detectors for activating a video camera, the transmittal of camera images to a location remote or distant from the vehicle, camera systems with 360 degree fields of view, the capture of audio data, and the use of night vision-type technology.

Notwithstanding the long time existence of the above-described problems, and the various attempts in the art to address them, no known environmental monitoring system exists which addresses or solves each of the above delineated drawbacks. More particularly, no known vehicle camera system provides a mechanism by which important vehicle blind spots are effectively eliminated while simultaneously allowing the vehicle operator to maintain a normal head orientation which, itself, does not present substantial safety issues.

In view of the above enumerated drawbacks, it is apparent that there exists a need in the art for apparatus and/or methods which solve and/or ameliorate at least one of the above drawbacks related to known vehicle mounted camera systems. It is a purpose of this invention to fulfill those needs as well as other needs in the art which will become more apparent to the skilled artisan once given the following disclosure.

### SUMMARY OF THE INVENTION

Generally speaking, this invention addresses the above-described needs in the art by providing:

an automobile environmental monitoring system for visually monitoring a defined area proximal a vehicle during directional locomotion thereof, the environmental monitoring system comprising:

a first camera mounted at a first rearward facing location on a vehicle so as to capture a first set of images generally rearward of the vehicle;

a second camera mounted at a second rearward facing location on a vehicle so as to capture a second set of images generally rearward of the vehicle;

an image display apparatus in data communication with the first and the second cameras, the image display apparatus having a viewing screen capable of simultaneously displaying images collected by the first and the second cameras, the viewing screen being mounted at a location proximal a windshield of the vehicle; and

a power supply for supplying power to the first and second cameras and the image display apparatus.

In another embodiment, this invention provides:

an automobile environmental monitoring system for visually monitoring a defined area proximal a vehicle during directional locomotion thereof, the environmental monitoring system comprising:

a first camera capable of being mounted at a first rearward facing location on a vehicle so as to capture a first set of images generally rearward of the vehicle;

a second camera capable of being mounted at a second rearward facing location on a vehicle so as to capture a second set of images generally rearward of the vehicle; and

an image display apparatus having a viewing screen capable of simultaneously displaying images collected by the first and the second cameras, the image display apparatus being so configured so as to be capable of being user mounted on a rear view mirror of a vehicle.

This invention will now be described with respect to certain embodiments thereof as illustrated in the following drawings wherein:

### BRIEF DESCRIPTION OF THE DRAWINGS

FIG. 1 illustrates a three-dimensional view of one embodiment of a vehicle environment monitoring system according to the subject invention.

FIG. 2 illustrates a side-profile view of the embodiment illustrated in FIG. 1.

FIG. 3 illustrates an embodiment of a wireless camera monitoring system depicted mounted on a vehicle trailer.

FIG. 4 illustrates an alternative embodiment of an image display apparatus according to one embodiment of the subject invention.

### DETAILED DESCRIPTION OF CERTAIN EMBODIMENTS

For a more complete understanding of the present invention and advantages thereof, reference is now made to the following description of various illustrative and non-limiting embodiments thereof, taken in conjunction with the accompanying drawings submitted herewith.

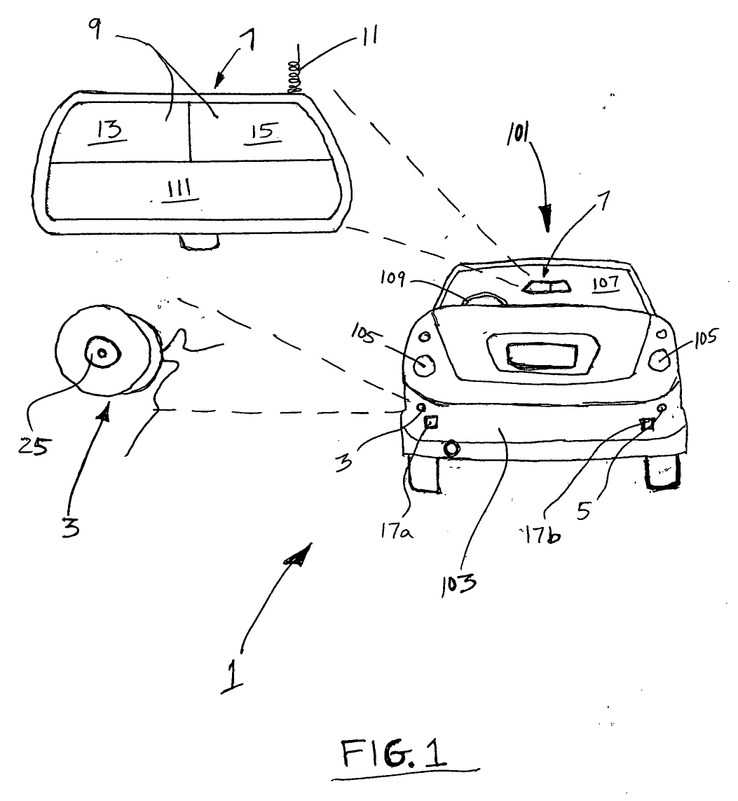

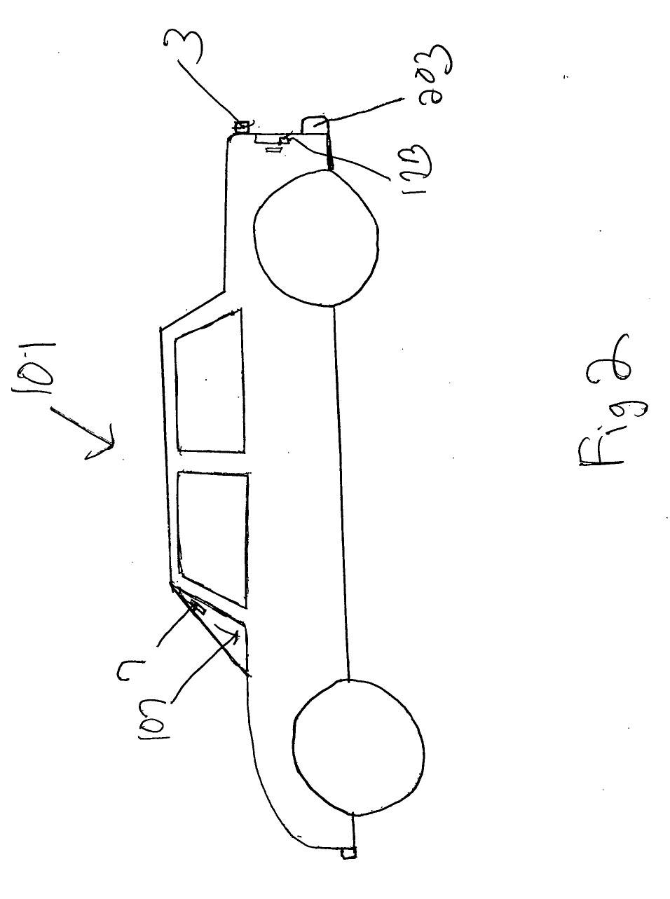

Referring initially to FIGS. 1 and 2, an exemplar automobile environmental monitoring system 1 according to one embodiment of the subject invention is illustrated therein. As can be seen in the figures, environmental monitoring system 1 generally comprises first and second cameras 3 and 5 mounted on a bumper 103 of vehicle 101 in data communication with image display apparatus 7 (configured for displaying images captured by the cameras). In order to maximize the viewing area captured by cameras 3 and 5, in preferred embodiments, the cameras are mounted on opposite sides of the rear bumper of the vehicle. Mounted as such with the cameras oriented or aimed appropriately, substantially all, if not all, of the area behind vehicle 1 can be imaged by the cameras (and displayed by display apparatus 7). Therefore, particularly when combined with a bifurcated display apparatus 7 as shown, important blindspots normally present when directionally operating a vehicle (e.g. such as in reverse) are eliminated. It is noted that although cameras 3 and 5 are illustrated as mounted on a vehicle bumper, such a mounting location is only an example, and alternative mounting locations which allow user connectability and disconnectability are, of course, contemplated (e.g. on or near the tail lights or turn signals, the undercarriage of the vehicle, or the rear window of the vehicle).

Turning now to the specific configuration of the image display, preferred embodiments of image display apparatus 7 are bifurcated into left and right display panels 13 and 15 respectively. Optionally, in at least one embodiment, a mirror 111 can be integrated with display apparatus 7 in order so that conventional rear view mirror-type functionality can be preserved which could prove important, particularly if there is a power failure with system 1 (or the vehicle) and or if the system discontinues functioning for any other reason, for example. In the embodiment as illustrated, left panel 13 is configured to display images captured by camera 3 (mounted on the left side of the vehicle) and right panel 15 is configured to display images captured by camera 5 (mounted on the right side of the vehicle). In this manner, when display apparatus 7 is mounted proximal the top center of windshield 107 (near or at where a conventional rear view mirror would be mounted), the area behind the vehicle which is monitored by cameras 3 and 5 can be viewed in a natural and logical manner (i.e. because the left panel corresponds to the left camera, and vice versa). Additionally, in effect, both the left and the right sides of the area proximal the rear of vehicle 1 can be viewed substantially simultaneously without requiring that the drivers head be turned in one direction or another, for example (i.e. by merely shifting ones gaze from one screen to the other). Moreover, because modern drivers are accustomed to using conventional rear view mirrors on a habitual basis, due to the mounting location of display apparatus 7, no new driving skills or habits are required to be learned or acquired.

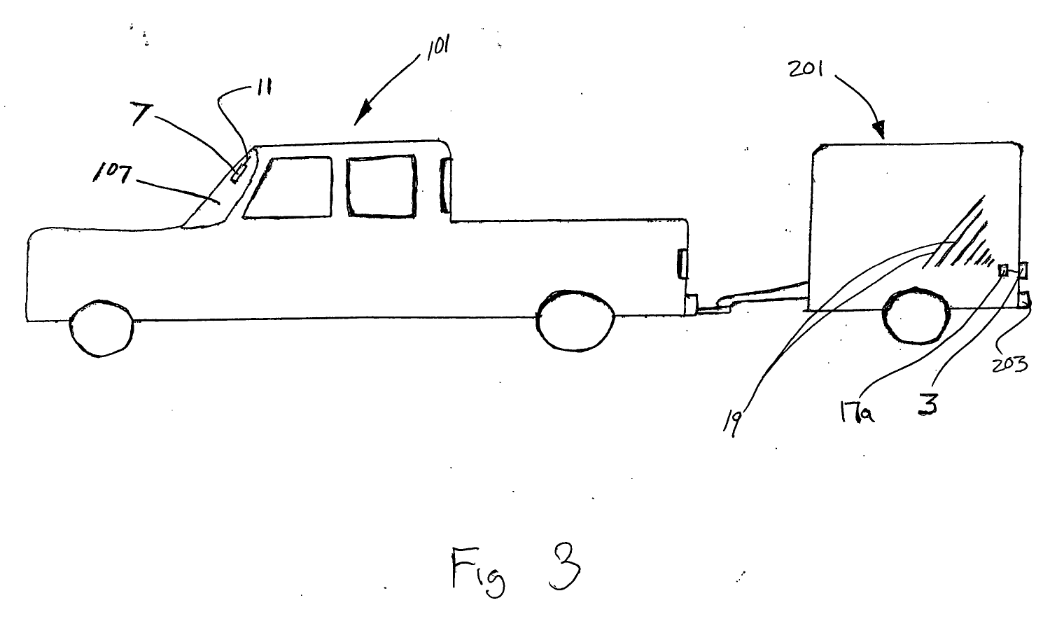

In at least one embodiment of the invention, in order so that cameras 3 and 5 can communicate data to display apparatus 7, transmitters and an antenna are provided for sending and receiving data signals respectively. Referring specifically still to FIG. 1, in this, regard, cameras 3 and 5 are each illustrated with associated transmitters 17a and 17b, respectively, for transmitting images captured by the cameras to antenna 11 located on or proximal display apparatus 7. Using a wireless system, as such, simplifies the installation of system 1 as no hard wires in such an embodiment are present to complicate installation (it is, nevertheless, contemplated that hard wired systems can be employed). Furthermore, the use of a wireless system enables system 1 to be adapted for use on many vehicle types without requiring that modifications to the system be made. For example, because a particular wiring harness type or length is not required when using a wireless system, system 1 can be installed on a trailer 201, for example, such as illustrated in FIG. 3 (with image data being transmitted via radio frequency signals 19).

Also aiding the adaptability of system 1 to multiple vehicle types, in some embodiments of the invention, system 1 is equipped with integrated power supplies for the cameras and the display monitor. In embodiments, in which a wireless system is employed, additional power supplies can be provided to power the transmitters (or the camera power supplies can be shared by the transmitter, for example). As an alternative to independent power supplies, either the display apparatus, or the cameras, or both can be powered by the battery power of the vehicle. In such embodiments, the components of system 1 simply are hardwired into the electrical system of the vehicle.

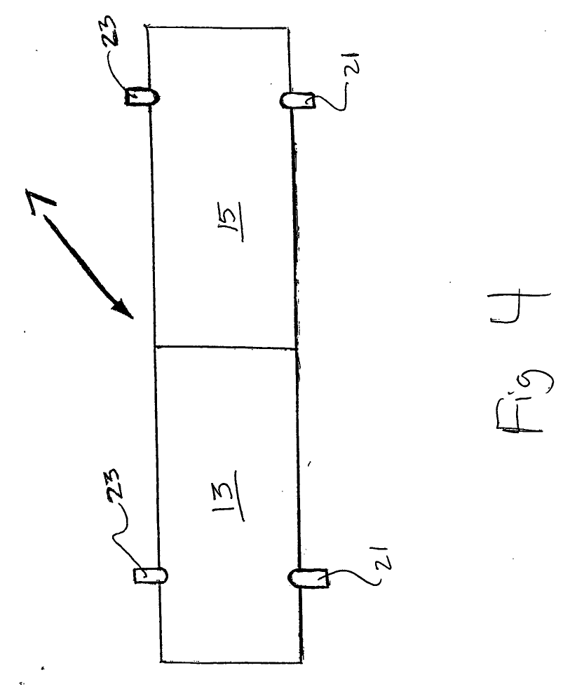

Although the embodiment of display apparatus 7 depicted in FIG. 1 is a particularly useful display configuration (and may be mounted semi-permanently on the vehicle windshield, for example), alternative configurations of display apparatus 7 are contemplated. More specifically, as illustrated in FIG. 4, a simplified version of display apparatus 7 can be employed with system 1. Using such an embodiment, rather than mounting the display on the windshield itself, mounting clips are provided so that display 7 can be user connected (or disconnected) to an existing rear view mirror. For example, clips 23 can be used to mount display 7 to the underside of a rear view mirror, or, alternatively, clips 21 can be used to mount the display to the top surface of a rear view mirror (according to personal preferences, for example). Although not illustrated in FIG. 4, further alternative clip types which would permit display 7 to be side mounted (on either side) of a rear view mirror are possible. It is noted that the illustrated clips are merely representations of one clip type and that many alternative clip types (or Velcro straps, for example) can be used with a high level of effectiveness. Such alternative clip types might employ adjustable biasing screws, for example, or contoured clamps for conforming to the configuration of a rear view mirror frame. Moreover, in order so that system 1 can be sold aftermarket, it is preferred, in some embodiments, that the various clips be user attachable and detachable (and thus the display as well).

In order to enhance the safety of system 1 in some embodiments, the system is capable of monitoring the operational condition of a vehicle transmission. In such an embodiment, for example, system 1 will activate, or turn on, when a vehicle is shifted into reverse and deactivate, or turn off, when the vehicle is shift back into drive. This, in effect, prevents potentially distracting images from being displayed when the vehicle is being operated in a forward direction. Notwithstanding such embodiments, alternative embodiments in which the cameras and display can be manually turned on or off are contemplated as are embodiments in which the system remains on or activated during any directional motion of the vehicle (e.g. any time the vehicle transmission is not in “park”).

Turning now to the specifics of cameras 3 and 5, and referring now again to FIG. 1, it is noted that although various lens types or lens covers can be employed with system 1, a wide angle lens is preferable in some embodiments because of the large field of view that can be obtained. Such lenses are particularly helpful in situations where an object is very close such when a vehicle is near a curb or other object or when the vehicle is being “tailgated”, for example. In embodiments which employ lens covers, covers of a polarizing or anti-fog type, such as cover 25, (or some other type or combination) can be used. In yet another alternative embodiment, cameras 3 and 5 can be oriented so that their fields of view overlap in order to produce depth of field (so that distances between the vehicle and surrounding objects can be better ascertained).

Once given the above disclosure, many other features, modifications, and improvements will become apparent to the skilled artisan. Such other features, modifications, and improvements are therefore considered to be part of this invention.

I claim:

1. An automobile environmental monitoring system for visually monitoring a defined area proximal a vehicle during directional locomotion thereof, said environmental monitoring system comprising:
a first camera mounted at a first rearward facing location on a vehicle so as to capture a first set of images generally rearward of said vehicle;
a second camera mounted at a second rearward facing location on a vehicle so as to capture a second set of images generally rearward of said vehicle;
an image display apparatus in data communication with said first and said second cameras, said image display apparatus having a viewing screen capable of simultaneously displaying images collected by said first and said second cameras, said viewing screen being mounted at a location proximal a windshield of said vehicle; and
a power supply for supplying power to said first and second cameras and said image display apparatus.

2. A system according to claim 1 wherein said system is capable of detecting an operational condition of a vehicle transmission; and
wherein when said vehicle transmission is detected to be in a reverse drive position, said first and said second cameras and said image display apparatus are activated; and
wherein when said vehicle transmission is detected to be in a forward drive position, said first and said second cameras and said image display apparatus are deactivated.

3. A system according to claim 2 wherein said viewing screen is bifurcated into first and second viewing areas capable of displaying images collected by said first and said second cameras, respectively.

4. A system according to claim 3 wherein said first and said second cameras are user connectable and disconnectable to and from a rear portion of said vehicle.

5. A system according to claim 4 wherein said viewing screen is selectively user connectable and disconnectable from a rear view mirror of said vehicle.

6. A system according to claim 5 further including display mounting clips capable of connecting said image display apparatus at a location in a vehicle selected from the group consisting of:
proximal a top edge of a rear view mirror, proximal a bottom edge of a rear view mirror, proximal a side edge of a rear view mirror, and on a windshield proximal a top center portion thereof.

7. A system according to claim 5 wherein said bifurcated viewing screen comprises a combination of said first and said second viewing areas and a rear view mirror, and wherein said first camera is mounted on a left, rear-portion of said vehicle, and said second camera is mounted on a right, rear-portion of said vehicle; and
wherein said first viewing area comprises a left viewing screen for displaying images captured by said first camera; and
wherein said second viewing area comprises a right viewing screen for displaying images captured by said second camera.

8. A system according to claim 7 wherein said first viewing is located adjacent to said second viewing area and said rear view mirror is located adjacent to said first and said second viewing areas.

9. A system according to claim 6 further including camera mounting clips capable of connecting said first and said second cameras at locations on a rear portion of said vehicle selected from the group consisting of:
a bumper, tail lights, turn signal lights, a trunk, a vehicle undercarriage, and wheel wells.

10. A system according to claim 9 wherein said display mounting clips are adjustable.

11. A system according to claim 9 wherein said first and second cameras transmit images to said image display apparatus via a mechanism selected from the group consisting of:
a wireless data stream and a hard wire connection between said first and said second cameras and said image display apparatus.

12. A system according to claim 9 further including a camera transmitter for transmitting images collected by said first and said second cameras and including a receiver in data communication with said image display apparatus, said receiver being configured to receive image data transmitted by said camera transmitter.

13. A system according to claim 11 wherein said first and said second cameras are configured with wide-angle lenses.

14. A system according to claim 13 wherein said first and said second cameras include lens covers selected from the group consisting of:
polarized lens covers and anti-fog lens covers.

15. An automobile environmental monitoring system for visually monitoring a defined area proximal a vehicle during directional locomotion thereof, said environmental monitoring system comprising:
a first camera capable of being mounted at a first rearward facing location on a vehicle so as to capture a first set of images generally rearward of said vehicle;
a second camera capable of being mounted at a second rearward facing location on a vehicle so as to capture a second set of images generally rearward of said vehicle; and
an image display apparatus having a viewing screen capable of simultaneously displaying images collected by said first and said second cameras, said image display apparatus being so configured so as to be capable of being user mounted on a rear view mirror of a vehicle.
